(19) United States
(12) Patent Application Publication
(10) Pub. No.: US 2005/0273709 A1
(43) Pub. Date: Dec. 8, 2005

(54) System and method for conversion of legacy language conforming data entries to industry-standard language conforming data entries

(76) Inventors: Ira Lough, North Smithfield, RI (US); Knowles Sinkler, West Warwick, RI (US); James Mycroft, Canterbury, CT (US)

Correspondence Address: KENYON & KENYON, ONE BROADWAY, NEW YORK, NY, 10004, US

(21) Appl. No.: 10/861,180

(22) Filed: Jun. 4, 2004

(51) Int. Cl. G06F 17/00

(52) U.S. Cl. 715/517

(57) ABSTRACT

A system and method for conversion of data entries input in accordance with a legacy data structure to be in accordance with an industry-standard data structure is disclosed. An extraction utility may generate an extraction class based on a compiler stab information, and the extraction class may extract a data entry input in accordance with a legacy data structure, may convert the data entry, and may output the data entry in accordance with an industry-standard data structure.

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Data entry and processing environments may provide for data entries, e.g., that are input by a user. Alternatively, the data entries may be input in other ways, for example, automatically in response to some event or process. The data entries may be structured in an infinite number of ways. For example, in one instance, the data entries may be structured to include two data elements. The first data element may be a numerical value. The second data element may be a character array of 10 characters. In another instance, the data entries may be structured to include three data elements. The first data element may be a character array of 5 characters. The second and third data elements may each be a numerical value. A particular data element of a data entry can itself be structured to include more data elements.

Computer applications, e.g., software, may operate upon the data entries. Since the data entries may be structured in various ways, the application that operates upon the data entries may require information that describes the structure of the data entries. Otherwise, the application may treat the data entries improperly. For example, without the information, the application may treat as a numerical value a data element that is a character array. Consequently, a data entry may need to conform to a predefined structure. In this way, information that describes the predefined structure, and by extension the structure of the data entry, may be made available. The data structure definition may be used as the information that describes the predefined structure. A file that includes a collection of data elements of a data entry with a description of each data element may then be generated. The description may be in terms associated with the data structure definition. The application that is to operate upon the data entry may operate upon the described data elements of the data entry that is within the file, and thereby correctly operate upon each data element of the data entry in accordance with the information. Alternatively, the generation of the collection of data elements with descriptions may be eliminated and the application itself may instead be programmed to correctly operate upon the data entry. According to this latter instance, a data structure definition defines the structure according to which a data entry conforms, and also manipulates the functionalities of an application.

Often computer applications of one data processing environment provide functionalities not provided by computer applications of other data processing environments. Consequently, the possibility arises that a data entry, input within one data processing environment, may be operated upon by an application of a different data processing environment.

However, data processing environments may differ in the way in which to define a data structure. If a data structure is defined in one data processing environment, the data structure definition may not be interpreted by a second data processing environment. Also, the definition of the data structure in one data processing environment may not manipulate the functionalities of an application of a second data processing environment. The possibility therefore arises that the application that is to operate upon the data entry is unable to do so because the application cannot interpret the data structure definition and because the functionalities of the application have not been manipulated to correctly process data entries. For example, a data structure may be defined in and for a lottery game management system. Point of sale devices of the lottery game management system may be used for inputting lottery game transaction data entries. Other data management applications of the lottery game management system may be used to store the inputted data entries, and to keep track of winning lottery data entries. Still further tasks to be performed upon the data entries, e.g., statistics reporting, may be outsourced to data processing applications that may not be of the lottery game management system. However, these latter applications may not be able to perform their assigned tasks since they are not applications of the system in which the data structure for the lottery data entries was defined. Other systems in which this problem may arise include, e.g., bill pay systems, pre-paid phone card systems, government licensing systems, e.g., systems of the department of motor vehicles, event ticket sales systems, and other transaction processing systems.

Accordingly, there is a need in the art for a system and/or method that extracts data entries input in a first processing environment and converts the data entries so that an application of a second processing environment, that cannot operate upon data entries that are in accordance with a data structure defined in the first processing environment, can operate upon the data entries.

### BRIEF DESCRIPTION OF THE DRAWINGS

FIG. 1 is a flowchart that illustrates an example procedure in which a number extraction classes may be generated and used for various defined legacy data structures, according to an example embodiment of the present invention.

FIG. 2 is a flowchart that illustrates an example procedure in which a number of versions of an extraction class may be generated and used, according to an example embodiment of the present invention.

FIG. 3 is a block diagram that illustrates the components of an example lottery system, according to an example embodiment of the present invention.

FIG. 4 is a flowchart that illustrates an example procedure for generating and using an extraction class, according to an example embodiment of the present invention.

FIG. 5 is an illustration of an example legacy data structure defined in the ‘C’ language, according to an example embodiment of the present invention.

FIG. 6 is an illustration of an example definition of a primitive structure layout, according to an example embodiment of the present invention.

FIG. 7 is an illustration of an example industry-standard data structure, according to an example embodiment of the present invention.

FIG. 8 is an illustration of an example extraction class, according to an example embodiment of the present invention.

FIG. 9 is an illustration of an example data output in accordance with an industry-standard data structure, according to an example embodiment of the present invention.

FIG. 10 is a block diagram that illustrates the components of an example system, according to an example embodiment of the present invention.

### DETAILED DESCRIPTION OF EXAMPLE EMBODIMENTS

Embodiments of the present invention generally relate to conversion of data entries input in accordance with one data structure. The data entries may be converted to be in accordance with another data structure. More particularly, embodiments relate to an extraction utility that creates extraction classes to convert data entries input in accordance with a legacy data structure to be in accordance with an industry-standard data structure and to be operated upon by non-legacy applications.

A data entry is in accordance with a legacy data structure when applications of the legacy processing environment may operate upon the data entry, but applications of other processing environments may not be able to operate upon the data entry. This circumstance may arise when the data entry is input within a legacy processing environment. When input, a data entry may be in the form of a collection of bits within memory. Since the data entry, entered within the legacy processing environment, is in accordance with the legacy data structure, applications of the legacy processing environment may operate upon the bits, but applications of other processing environments may not be able to operate upon the data entry bits.

A data entry is in accordance with an industry-standard data structure when data of the data entry is expressed in terms associated with the industry-standard data structure. When in accordance with the industry-standard data structure, the data entry may be in the form of a document that includes a collection of data elements and descriptions, rather than a collection of bits. The descriptions may describe the data elements in terms associated with the industry-standard data structure. In this latter form, applications that are not of the legacy processing environment may operate upon the data entry.

A legacy language may be a language with which only a select subset of data processing environments can operate, e.g., a proprietary language. An industry-standard language may be a language with which most, if not all, data processing environments can operate. If a language is one with which a data processing environment can operate, then, e.g., an application of the environment can be manipulated by program instructions written in the language. If a data entry is input in accordance with a data structure defined by the language, then the application of the environment can operate upon the data entry.

A legacy data structure may be a data structure defined according to a legacy language. By contrast, an industry-standard data structure may be a data structure defined according to an industry-standard language. For example, an application that is not of a processing environment that operates using the ‘C’ language, often will not be able to operate upon a data entry input in accordance with a data structure defined in the ‘C’ language. However, a data entry that is input in accordance with, or that has been interpreted to be in accordance with a data structure defined in the Extensible Markup Language (XML) may be in a form upon which applications of most data processing environments can operate, since XML is an industry-standard language.

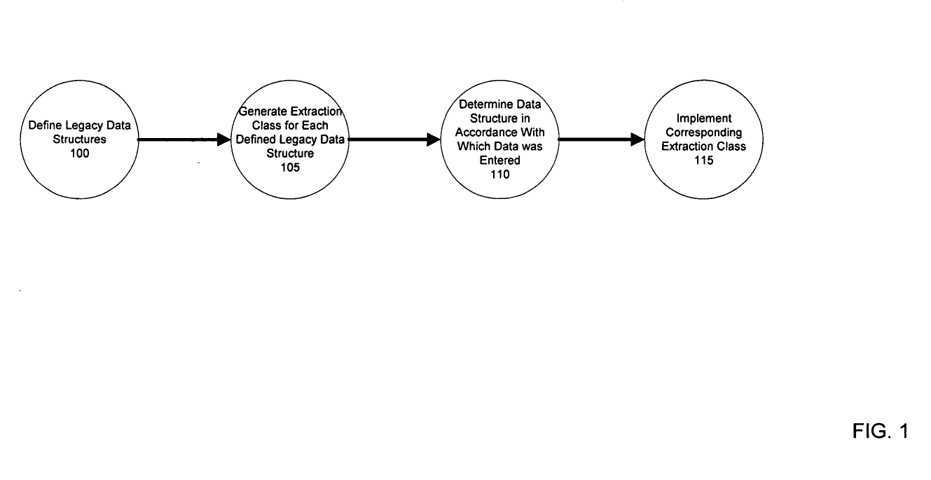

FIG. 1 is a flowchart that illustrates an example procedure, according to an example embodiment of the present invention, in which extraction classes may be generated for each of many legacy data structures defined in the legacy language. For example, in 100, three data structures may be defined according to the legacy language, e.g., the ‘C’ language. In 105, the extraction utility may generate for each defined data structure an extraction class. When, for example, a user inputs a data entry into a data entry application, the extraction utility may determine, in 110, the particular legacy data structure in accordance with which the data entry was input. For example, if a user inputs the data entry in response to the data entry application's request for user information, the extraction utility may determine that the data entry is in accordance with a particular one of the three legacy data structures that contains a string data element for the user's name and an integer data element for the user's age. In 115, the extraction utility may then implement the extraction class generated for the relevant legacy data structure to convert the data so that it is in accordance with the industry-standard data structure that corresponds to the relevant legacy data structure. In this way, a data processing environment that is configured to operate upon or manipulate data that is in accordance with the industry-standard data structure, may operate upon or manipulate the data entry, even though the data entry was input in accordance with a legacy data structure of a legacy language with which the data processing environment is not configured to operate.

Consequently, in one example embodiment of the present invention, each time a legacy data structure is defined in the legacy language in 100, a corresponding extraction class may be generated, in 105, to convert a data entry input in accordance with the defined legacy data structure. To this end, the extraction utility may detect a new legacy data structure definition and generate an extraction class for the detected new legacy data structure.

In an example embodiment of the present invention, a particular legacy data structure may be subject to versioning. The extraction utility may detect the definition of the new version of the legacy data structure and may generate an extraction class to convert data entries to be in accordance with an industry-standard data structure that is representative of the new version of the legacy data structure. The extraction utility may replace an extraction class, generated to convert data entries input in accordance with the first version of the legacy data structure, with another extraction class, generated to convert data entries input in accordance with the second version of the legacy data structure.

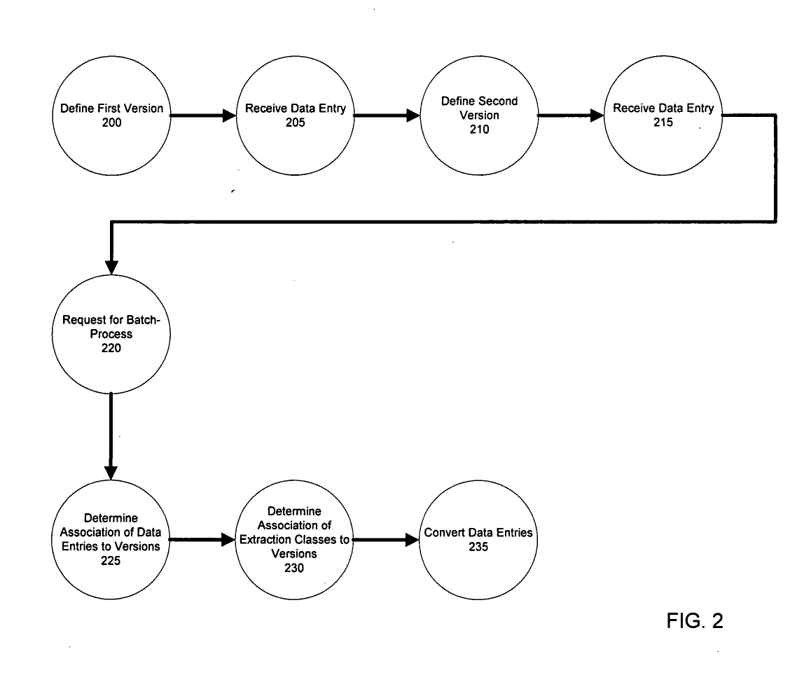

FIG. 2 is a flowchart that illustrates versioning according to an alternative embodiment of the present invention, in which batch-processing of many data entries is provided for. Between each batch-process, many versions of a legacy data structure may be defined and many data entries may be input. In 200, a first version of a legacy data structure may be defined. In 205, after the first version of the legacy data structure is defined but before a second version of the legacy data structure is defined, a data entry may be input in accordance with the first version of the legacy data structure. Subsequently, in 210, a second version of the legacy data structure may be defined. Subsequent to the definition of the second version of the legacy data structure, in 215, a new data entry may be input in accordance with the second version of the legacy data structure. Subsequent to the entry of the new data entry, a data processing environment, configured to operate with industry-standard structured data and not with legacy structured data, in 220, may attempt a batch process of the first and second data entries. This batch process may require the first data entry to be converted in accordance with an extraction class corresponding to the first version of the legacy data structure, and the second data entry to be converted in accordance with an extraction class corresponding to the second version of the legacy data structure. According to this embodiment, the extraction utility may maintain both extraction classes, rather than replace one extraction class with another extraction class.

According to this embodiment, in 225, the extraction utility may determine which data entry was input according to the first version of the legacy data structure and which data entry was input after the definition of and in accordance with the second version of the legacy data structure. In 230, the extraction utility may also determine which extraction class corresponds to the first version of the legacy data structure and which extraction class corresponds to the second version of the legacy data structure. Based on these determinations, in 235, the data entries may be converted, the first data entry by the first extraction class, and the new data entry by the second extraction class.

To determine by which version of a data extraction class a data entry is to be converted, a key may be associated with each extraction class and with each data entry. An example key may be a date, or more particularly a time. For example, a key associated with a version of an extraction class may be the time when the version of the legacy data structure to which the extraction class corresponds was defined. The key associated with a data entry may be the time when the data entry was input. If, for example, the time of the data entry is earlier than the time of the definition of a third version of the legacy data structure but later than the time of the definition of a second version of the legacy data structure, then an extraction class that corresponds to the second version of the legacy data structure may be used to convert the data entry to be in accordance with an industry-standard data structure.

In an example embodiment of the present invention, a legacy data structure, in accordance with which a data entry is input, may be partly defined and partly based on legacy data entry applications used for inputting the data entry. For example, using the ‘C’ language, a data structure may be defined. Additionally, a data entry application programmed in the ‘C’ language may be used for inputting data entries. The data entry application may format and store data elements of the data entries in a particular way. The reason the data entry application formats and/or stores the data elements in the particular way may be, for example, based on efficiency concerns. Data elements may be stored, for example in an order reverse of the order in which the data elements were input. In another example embodiment, the legacy data entry application may encode data of the data entries in nibbles, rather than in bytes. The extraction utility may generate extraction classes that convert data entries input in accordance with a legacy data structure, even when the legacy data structure is partly based on data manipulation by legacy data entry applications, aside from legacy data structure definitions.

For example, a legacy data structure definition may define a data structure with an integer data element and then a character array data element. A legacy data entry application may store a data entry so that the character array data element is stored in an anterior memory location and so that the integer data element is stored in a posterior memory location. The extraction class may properly convert the data entry to reflect that the anteriorly stored data element is the character array data element and that the posteriorly stored data element is the integer data element.

In an example embodiment of the present invention, data entries may include data that corresponds to some legacy data structures and may omit data that corresponds to other legacy data structures. For example, a legacy data structure may be defined for input of a set of numbers for a lottery ticket. A second legacy data structure may be defined for input of winnings information, e.g, a winnings amount, for the lottery ticket. However, not all lottery tickets are winnings tickets. Therefore, some data entries, e.g., where a data entry includes all data concerning a lottery game transaction, may omit data that corresponds to the defined winnings data structure.

A bitmap may be used to indicate which of the defined data structures are represented in a particular data entry. In an example embodiment of the present invention, the extraction class may decode bitmaps and convert data entries accordingly.

In an example embodiment of the present invention, the extraction class may be platform independent. Platforms may vary between various computers. For example, one computer may use a 32 bit architecture, in which the computer operates on a 32 bit word, while another computer may use a 16 bit architecture, in which the computer operates upon a 16 bit word. A definition of a data element of type “int” may allow for 16 bits of data if the data entry is input using the computer of 16 bit architecture, and 32 bits of data if the data entry is input using a computer of 32 bit architecture. Similarly, one computer may use a big-endian architecture, while another computer may use a little-endian architecture. The extraction utility may generate an extraction class that extracts and converts data entries, regardless of the computer architecture according to which the data entry was input.

In an example embodiment of the present invention a filtering mechanism may be provided that enables the selection of particular data elements of the extracted data entries to be converted. Depending on the particular jobs performed by a particular computer application, some data elements of a data entry may be relevant, while other data elements of the data entry may be irrelevant. In one example embodiment, in accordance with the filtering mechanism, the data extraction class may convert only the selected data elements. In an alternative embodiment, the extraction class may convert the entire data entry to be in accordance with the industry-standard data structure, but then output only relevant data elements to a computer application.

According to the latter embodiment, the extraction class may output data elements of a particular data entry to a number of computer applications. For each computer application, the relevant data elements may differ. Consequently, the data elements output by the extraction class to the various computer applications may differ between computer applications.

In one example embodiment, the filtering mechanism may be automatically implemented based on the particular computer application to which the converted data entry is to be outputted. In an alternative embodiment, the extraction utility may provide a user interface. The extraction utility may construct a list of data elements, e.g., one for each industry-standard data structure defined within the extraction utility. The extraction utility may provide the list to a user via the user interface. The list may be in any conventional form for providing lists. The user may select which of the listed data elements the extraction class is to convert (or output). For example, a user may click on a particular listed data element to indicate a selection of the data element. Alternatively, the user may enter in a text box a selected data element. Other conventional ways to select an item from a list may be used. The data extraction class may then be adapted to perform its tasks according to the selections.

In an example embodiment of the present invention, a filtering mechanism may be provided that enables the selection of particular data elements of data entries to be extracted by the data extraction class. According to this embodiment, a data store, e.g., a data buffer, may contain data, for example of many data entries input in a number of transactions. For particular computer applications, only some data entries may be relevant for the computer applications' jobs. The filtering mechanism may cause the data extraction class to extract only those portions of the data store that are relevant. The filtering mechanism may indicate to the data extraction class a set of criteria. The data extraction class may then check the data within the data store to determine whether a particular portion of the data is of a data entry that meets the criteria. If the portion of the data is of a data entry that meets the criteria, the data extraction class may extract and convert the portion of the data. Like the filtering mechanism discussed in the previous embodiments, this filtering mechanism may be automatically triggered according to the computer applications that are implemented, or, alternatively, may be triggered by user selections.

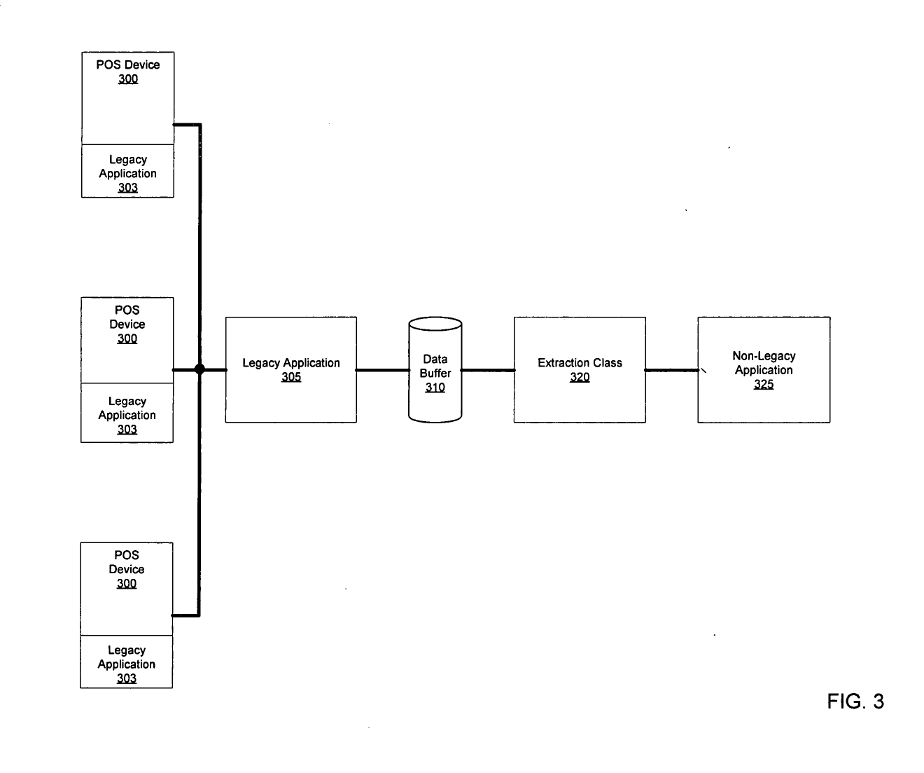

In an example embodiment of the present invention, a data entry input in accordance with a legacy data structure and converted to be in accordance with an industry-standard data structure, may include lottery game related data. FIG. 3 is a block diagram that illustrates components of a network for processing lottery game transactions. Transactions, e.g., for buying lottery tickets, may take place at numerous point of sale devices 300, e.g., each device 300 located in a different place. Example point of sale devices include online lottery ticket terminals, instant ticket vending machines, conventional point of sale terminals modified to distribute lottery tickets, etc. A buyer may, for example, choose a particular lottery game, e.g., a particular type of lottery ticket, e.g., a scratch-off lottery ticket, an on-line instant lottery ticket, a future-draw lottery ticket, etc. The buyer may enter lottery ticket numbers. Alternatively, numbers may be pre-printed, or may be selected by a ticket selling application, e.g., a quick pick. Each point of sale device may include a legacy application 303 that may generate a data entry according to a legacy data structure. Each generated data entry may include information regarding, e.g., the type of lottery game purchased, the location of the particular point of sale device 300, the selected numbers of a lottery ticket, a time of sale, a drawing date for the purchased lottery ticket, etc. Each legacy application 303 may be in communication with central legacy application 305. Central legacy application 305 may collect the data entries generated at each point of sale device 300 and store the data entries in a data buffer 310. Extraction class 320 may extract each data entry and convert each data entry to be in accordance with an industry-standard data structure. After the conversion, one or more non-legacy applications 325 may receive the data entries and perform various operations upon the data entries. For example, non-legacy application 325 may calculate statistics based upon the data entries, e.g., identification of purchase volume at various locations, lottery games most often purchased, etc. Non-legacy application 325 may further generate reports regarding lottery game purchases, e.g., lottery game statistics reports.

In alternative example embodiments of the present invention, a data entry input in accordance with a legacy data structure and converted to be in accordance with an industry-standard data structure, may include data of bill pay systems, pre-paid phone card systems, government licensing systems, e.g., systems of the department of motor vehicles, event ticket sales systems, and other transaction processing systems.

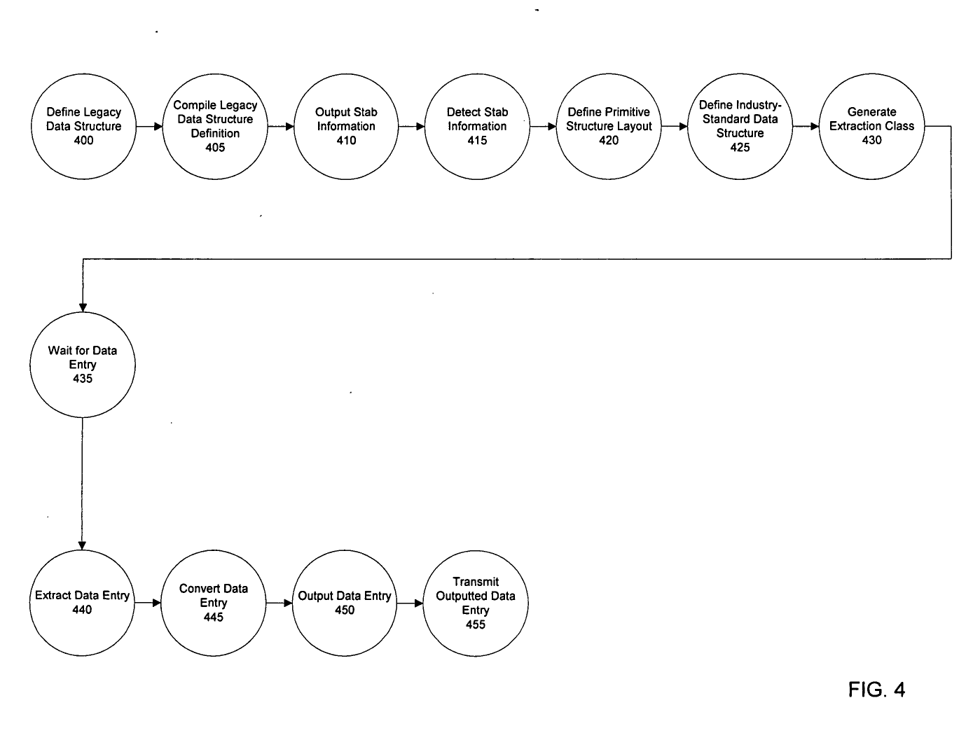

FIG. 4 is a flowchart that illustrates an example procedure in which an extraction class may be generated and then used to extract, convert, and output data entries. In 400, a legacy data structure may be defined, e.g., in the ‘C’ language. In 405, the legacy data structure definition may be compiled in a compiler. In 410, the compiler may output stab information to describe the compiled program that defined the legacy data structure. In 415, the extraction utility may detect that the compiler has outputted new stab information. In response to this detection, the extraction utility may generate a structure-layout data. This may be further broken down into two parts. First, in 420, the extraction utility may employ a Perl utility to parse the stab information and to define and output in an ASCII file a primitive structure layout. Then, in 425, based on the primitive structure layout, the extraction utility may define an industry-standard data structure that represents the primitive data structure in an industry-standard language, such as XML. In 430, for the defined industry-standard data structure, the extraction utility may generate an extraction class to retrieve data entries that are in accordance with the defined legacy data structure and to convert the entry to be in accordance with the defined industry-standard data structure.

The generated extraction class may then be repeatedly used for all data entries input in accordance with the defined legacy data structure. To that end, in 435, the extraction class may wait for a data entry. In 440, after a data entry has been input, the extraction class may extract data of the data entry, e.g., from a data buffer. In 445, the extraction class may convert the extracted data entry to be in accordance with the defined industry-standard data structure. In 450, the extraction class may output the converted data entry for transmission. In 455, the converted data entry may be transmitted to data processing applications, for example by using a communications protocol, such as TCP/IP, or any conventional communications protocol.

In an example embodiment of the present invention, the extraction class may be a Java extraction class, written in the Java programming language. The Java extraction class may call external Java routines to perform its tasks. For example, the Java extraction class may include two subroutines, one for retrieving into Java classes data entries from, for example data buffers, and another for converting the retrieved data so that it is in accordance with the defined industry-standard data structure.

The Java extraction class may use Java Document Object Models (JDOM) to convert data to be in accordance with the industry-standard data structure, e.g., an XML data structure.

In an example embodiment of the present invention, the extraction class may use particular Java subroutines to convert some data elements of a data entry but not other data elements of the data entry. For example, the ‘C’ language supports an unsigned integer data type. Java supports only signed data types. If an integer is signed, then the left-most bit, for example, may indicate the sign of the number. If an integer is unsigned, so that all values are, for example, positive, then the left-most bit is part of the number. For example, if an integer is made up of 8 bits and is unsigned, then the 8 bits can represent 256 possible values, in the range of 0 to 255. If the 8 bit integer is signed, then the 8 bits can only represent 128 possible values, in the range of 0 to 127. Consequently, a Java integer may not be able to represent any value of the unsigned integer type that is in the range of 128 to 255. If the ‘C’ language defined data structure includes a data element that is an unsigned integer type, the extraction class may call a Java routine to assign a Java data type that can handle values of an unsigned integer. For example, the called Java routine may assign to the data element a Long data type.

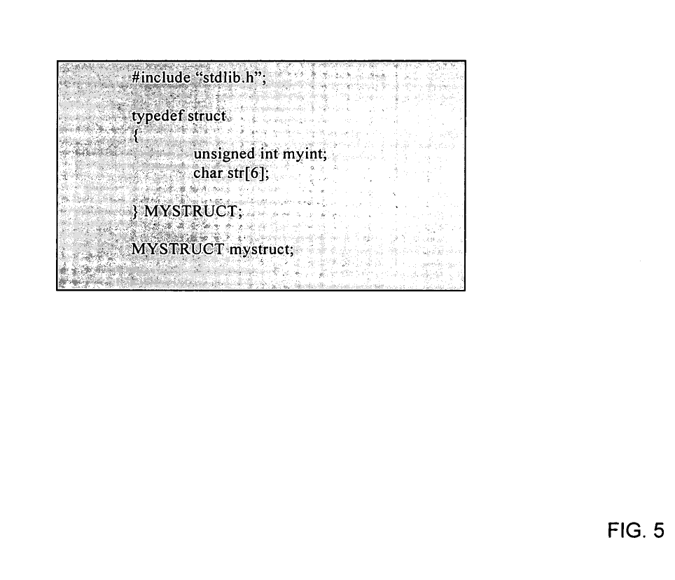

FIG. 5 illustrates an example of a legacy data structure defined in the ‘C’ language. According to the illustrated example embodiment, a structure named “MYSTRUCT” is defined. This structure is defined to include an integer named “myint,” and a character string named “str,” that may be as large as 6 bytes.

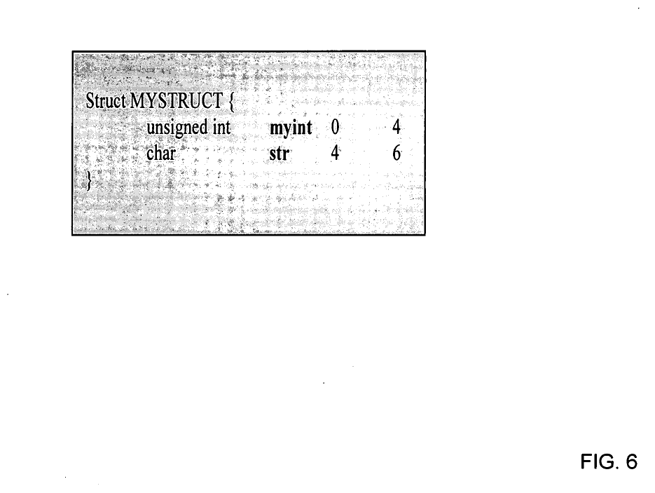

FIG. 6 illustrates an example of a definition of a primitive structure layout that is representative of the legacy data structure definition as illustrated in FIG. 5. According to the illustrated example embodiment, the Perl utility has generated a structure named “MYSTRUCT,” to include an integer named “myint,” and a character string named “str.” Additionally, “myint” and “str” are further defined by their beginning memory addresses (i.e. 0 for “myint” and 4 for “str”) and by their byte length (i.e. 4 bytes for “myint” and 6 bytes for “str”).

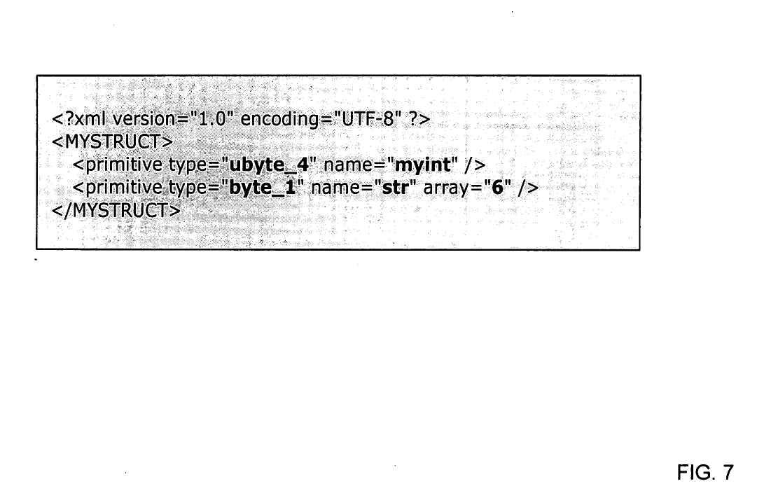

FIG. 7 illustrates an example of a definition of an industry-standard data structure, generated in XML, that is representative of the primitive structure layout definition as illustrated in FIG. 6. According to the illustrated example embodiment, the extraction utility has defined elements of a structure named “MYSTRUCT.” Instead of defining the data elements as integers or characters, the extraction utility has defined the data elements by name and a number of bytes. The character string of FIGS. 5 and 6 is defined here as an array of 6 sub-elements. Each sub-element is defined as having a length of 1 byte of data.

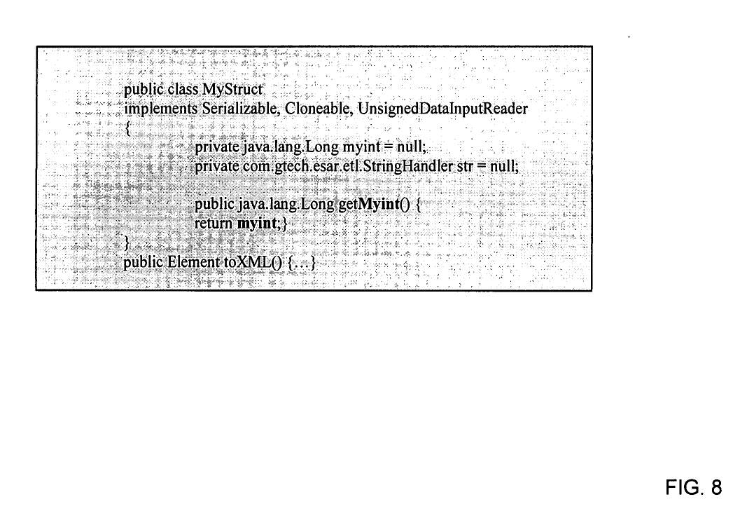

FIG. 8 illustrates an example of part of a Java extraction class that has been generated to convert data entries input in accordance with the ‘C’ language defined data structure of FIG. 5. The illustrated Java extraction class may extract the bits of a data entry, for example, from a data buffer, convert the extracted data entry to an XML document, and then output the converted data entry. The Java extraction class may implement other Java classes, such as “UnsignedDataInputReader,” which is used to extract data from the data buffer. The extraction class may use getMyint to extract the myint data element. Similarly, a getStr may be used to extract the str data element. After extracting the data entry, the Java extraction class may use a toXML subroutine to convert the extracted data to be in accordance with the XML defined data structure, for example, of FIG. 7.

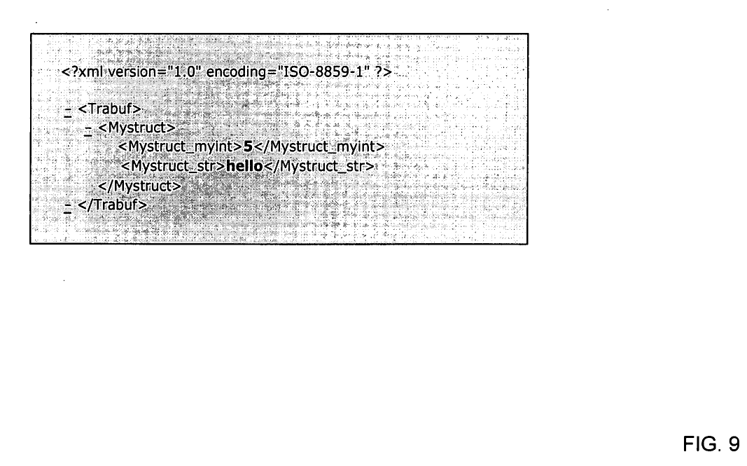

FIG. 9 illustrates an example of a data entry after it has been converted to be in accordance with the XML defined data structure of FIG. 7, so that the data entry may be operated upon by an application that is of a non-legacy processing environment. According to this embodiment a data entry included “5” as the specific instance of “myint” and “hello” as the specific instance of “str.” This XML representation of the data entry may be transmitted to data processing applications for processing and manipulation of the data entry.

According to an example embodiment of the invention, the extraction class may further include in the resulting XML the relationship among data elements of a data entry. For example, a structure called “CUSTOMER” may be defined. This structure may be defined, for example, to include an integer called Myint. The structure may further include another defined structure called “ADDRESS.” In ADDRESS may be defined another integer called Myint. The extraction utility may include XML tags, for example, that identify a particular data element's place in the hierarchy of the data structure. For example, the data may be converted to:

<Customer>

<Myint>5</Myint>
<Address>

<Address_Myint>10</Address_Myint>

</Address>

</Customer>

In this way, programs to which the converted data entries are output may generate relational databases based upon the data entries received from the extraction class.

For example, a first structure may be defined to include a number of data elements, including an integer called “Myint”; a number of instances of a second structure; and a single instance of a third structure. The second and third structures may each also include an integer called “Myint.” A relational database may be generated to include a table for the first structure, listing the first structure's data elements; and a table for the second structure, listing the second structure's elements. Since only one instance of the third structure is defined, a table may not be generated for the third structure. Rather, the third structure may be listed only as an element of the first structure. For each structure may be listed the integer “Myint.” Without a tag that identifies the Myint hierarchy, the structure to which a particular Myint belongs is not known when stored in a database. With the additional hierarchy information, each Myint may be tied to its structure when stored within a relational database. A table for the first structure would then have, for example, “first_structure_Myint,” “second_structure_Myint,” etc.; rather than “Myint” and “Myint.”

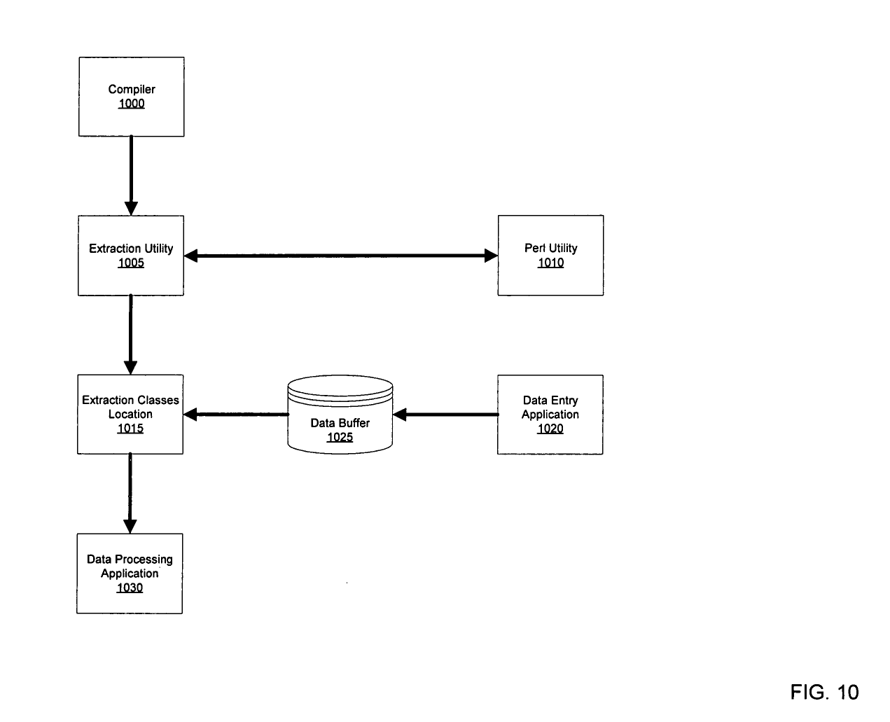

FIG. 10 is a block diagram that illustrates an example embodiment of the system components of the present invention. Compiler 1000 may compile a program, e.g., that defines a legacy data structure. When compiler 1000 compiles the program, compiler 1000 may output a stab information that describes the program. Extraction utility 1005 may retrieve the stab information from compiler 1000 and transmit the stab information towards Perl utility 1010. Perl utility 1010 may generate a primitive structure layout based on the stab information so that the primitive structure layout mirrors the legacy data structure compiled by compiler 1000. Perl utility 1010 may transmit the primitive structure layout towards extraction utility 1005. Extraction utility 1005 may define an industry-standard data structure representative of the primitive structure layout. Based on the industry-standard data structure, extraction utility 1005 may generate an extraction class, and may store the extraction class in extraction classes location 1015. More than one extraction class may be contained within extraction classes location 1015.

Data entry application 1020 may be used to receive input of data entries, e.g., from a user. The data entries may be stored in data buffer 1025. Extraction class 1015 may extract, for example in response to a request or at set times, the data entries, convert the data entries to be in accordance with the industry-standard data structure, and output the converted data entries. The outputted data entries may be transmitted towards data processing application 1030. Data processing application 1030 may then operate upon, manipulate, and/or use the data entries.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A method for processing a data entry that is input in accordance with a legacy data structure, comprising:
automatically generating a first extraction class according to a first stab information;
extracting the data entry via the first extraction class; and
converting the data entry to be in accordance with an industry-standard data structure.

2. The method of claim 1, further comprising:
generating a first structure-layout data according to the first stab information, the first extraction class generated according to the first structure-layout data.

3. The method of claim 2, wherein generating the first structure-layout data further comprises:
defining a primitive structure layout; and
defining the industry-standard data structure so that the industry-standard data structure is representative of the primitive structure layout,
the first extraction class generated according to the industry-standard data structure.

4. The method of claim 1, wherein the data entry includes a first entry input at a first time and a second entry input at a second time, the first and the second entries extracted by the first extraction class.

5. The method of claim 1, further comprising:
detecting the first stab information; and
detecting a second stab information,
wherein the first extraction class is generated after the first stab information is detected and before the second stab information is detected, and wherein a second extraction class is generated after the second stab information is detected.

6. The method of claim 5, wherein,
if the data entry is input before the second extraction class is generated, the data entry is extracted by the first extraction class, and wherein,
if the data entry is input after the second extraction class is generated, the data is extracted by the second extraction class.

7. The method of claim 6, wherein the data entry is extractible after the second extraction class is generated, even if the data entry is input before the second extraction class is generated.

8. The method of claim 7, further comprising:
storing a key from a first set of keys for and to be associated with the data entry; and
storing a key from a second set of keys for each of the first and the second extraction classes, each key from the second set of keys being associated with the extraction class for which the each key is stored,
wherein the key from the first set of keys indicates when the data entry was input, and
wherein each second key indicates when the each second key's associated extraction class was generated, the data entry extracted by one of the first and the second extraction classes in accordance with the keys.

9. The method of claim 8, wherein each key of the first and the second sets of keys is at least one of a date and a time.

10. The method of claim 3, wherein the industry-standard data structure is defined in accordance with Extensible Markup Language (XML).

11. The method of claim 1, wherein the legacy data structure is a ‘C’ language defined data structure.

12. The method of claim 1, wherein the first stab information is generated during a definition of the legacy data structure.

13. The method of claim 1, wherein the legacy data structure is partly defined by a legacy-language data structure definition and is partly defined by a legacy application's behavior.

14. The method of claim 3, wherein defining the primitive structure layout further comprises:
defining at least one data element type,
wherein the at least one data element type is assigned a unique name and is identified as one of a character, a character string, a character array, and an integer.

15. The method of claim 14, wherein defining the primitive structure layout further comprises:
assigning a unique beginning memory address and a byte length to the at least one data element type.

16. The method of claim 3, further comprising:
storing the definition of the primitive structure layout in an ASCII file.

17. The method of claim 1, wherein the first extraction class is generated for extracting and converting lottery-game data entries.

18. The method of claim 17, wherein a lottery-game data entry includes an indication of at least one of a lottery game type, a point of sale location, a set of selected numbers, and a time of sale.

19. The method of claim 18, wherein the lottery-game data entry is automatically generated during a lottery game sale transaction.

20. The method of claim 17, further comprising:
aggregating the lottery-game data entries from a plurality of point of sale devices; and
storing in a data buffer the aggregated entries,
wherein each of the stored lottery-game data entries is extracted from the data buffer and converted to be in accordance with the industry-standard data structure.

21. The method of claim 20, further comprising:
calculating lottery-game statistics based on the converted lottery-game data entries; and
generating a lottery-game statistics report.

22. The method of claim 1, further comprising:
outputting the converted data entry,
wherein the converted data entry includes a plurality of data elements, and
wherein only a first subset of the plurality of data elements is selected for output.

23. The method of claim 22, wherein the selection is an automatic selection of data elements that are relevant to tasks performed by a data processing application.

24. The method of claim 22, further comprising:
providing to a user a list of the plurality of data elements;
receiving the selection, the selection being a user choice from the list; and
outputting the data entry according to the selection.

25. The method of claim 1, wherein the extracted data entry includes a plurality of data elements, and wherein only a first subset of the plurality of data elements is selected for conversion.

26. The method of claim 25, wherein the selection is an automatic selection of data elements that are relevant to tasks performed by a data processing application.

27. The method of claim 25, further comprising:
providing to a user a list of the plurality of data elements;
receiving the selection, the selection being a user choice from the list; and
converting the data entry according to the selection.

28. The method of claim 1,
wherein the data entry includes a first data entry and a second data entry,
wherein the legacy data structure includes a first legacy data structure and a second legacy data structure,
wherein the first data entry is input in accordance with the first legacy data structure and the second data entry is input in accordance with the second legacy data structure, and
wherein only the first data entry is selected for the extraction.

29. The method of claim 28, wherein the selection is an automatic selection based on the first data entry's relevance to tasks performed by a data processing application.

30. The method of claim 28, further comprising:
providing to a user a listing of the first and the second legacy data structures;
receiving the selection, the selection being a user choice from the listing; and
extracting the first data entry according to the selection of the first legacy data structure.

31. The method of claim 1, wherein the first extraction class is a Java extraction class.

32. The method of claim 28, wherein at least one Java Document Object Model (JDOM) is implemented by the first extraction class to extract the data entry.

33. The method of claim 1, wherein, when input, the data entry is encoded in one of a plurality of nibbles and a plurality of bytes.

34. The method of claim 1, further comprising:
outputting the converted data entry; and
transmitting the outputted data entry toward at least one data processing application.

35. The method of claim 34, wherein the transmission is in accordance with a predetermined standard.

36. The method of claim 35, wherein the predetermined standard is Transmission Control Protocol/Internet Protocol (TCP/IP).

37. The method of claim 1,
wherein the legacy data structure includes a first and a second legacy data structure, and
wherein a bitmap indicates in accordance with which of the first and second legacy data structures the data entry was input.

38. The method of claim 37, wherein the first extraction class extracts the data entry in accordance with the bitmap.

39. The method of claim 37, wherein one of the first and second legacy data structures is defined for input of lottery game winnings data.

40. A method for data processing, comprising:
automatically generating an extraction class according to a stab information;
receiving a particular one of a plurality of lottery-game related data entries that is input in accordance with a legacy data structure;
extracting, via the extraction class, the data entry; and
converting the data entry to be in accordance with an industry-standard data structure.

41. The method of claim 40, wherein the data entry includes an indication of at least one of a lottery game type, a point of sale location, a set of selected numbers, and a time of sale.

42. The method of claim 41, wherein the data entry is automatically generated during a lottery game sale transaction.

43. The method of claim 40, further comprising:
aggregating the plurality of lottery-game related data entries from a plurality of point of sale devices; and
storing in a data buffer the aggregated entries,
wherein each of the stored data entries is extracted from the data buffer and converted to be in accordance with the industry-standard data structure.

44. The method of claim 43, further comprising:
calculating lottery-game statistics based on the converted data entries; and
generating a lottery-game statistics report.

45. The method of claim 40, wherein the data entry includes lottery game winnings data.

46. A computer system for processing a data entry that is input in accordance with a legacy data structure, comprising:
an extraction utility; and
a first extraction class generated by the extraction utility in accordance with a first stab information,
the first extraction class configured to extract the data entry and to convert the data entry to be in accordance with an industry-standard data structure.

47. The computer system of claim 46, wherein the extraction utility is configured to generate a first structure-layout data in accordance with the first stab information, the first extraction class generated in accordance with the first structure-layout data.

48. The computer system of claim 47, further comprising:
a Perl utility,
wherein the generation of the first structure-layout data includes a definition by the Perl utility of a primitive structure layout, and
wherein the generation of the first structure-layout data includes a definition of the industry-standard data structure so that the industry-standard data structure is representative of the primitive structure layout,
the first extraction class generated in accordance with the industry-standard data structure.

49. The computer system of claim 46, wherein the data entry includes a first entry input at a first time and a second entry entered at a second time, the first extraction class configured to extract the first and the second entries.

50. The computer system of claim 47, wherein the extraction utility is configured to detect the first stab information and a second stab information, to generate the first extraction class after the first stab information is detected and before the second stab information is detected, and to generate a second extraction class after the second stab information is detected.

51. The computer system of claim 50,
wherein the first extraction class is configured to extract the data entry if the data entry is input before the generation of the second extraction class, and
wherein the second extraction class is configured to extract the data entry if the data entry is input after the generation of the second extraction class.

52. The computer system of claim 51, wherein the data entry is extractible after the generation of the second extraction class, even if the data entry is input before the generation of the second extraction class.

53. The computer system of claim 52,
wherein the extraction utility is configured to store a key from a first set of keys for the data entry, and to associate the key with the data entry, the key configured to indicate when the data entry was input,
wherein the extraction utility is configured to store a key from a second set of keys for each of the first and the second extraction classes, and to associate each key from the second set of keys with the extraction class for which the each key is stored, the each key configured to indicate when the each key's associated extraction class was generated, and
wherein the data entry is extracted by one of the first and the second extraction classes in accordance with the keys.

54. The computer system of claim 53, wherein each key of the first and second sets of keys is at least one of a date and a time.

55. The computer system of claim 48, wherein the industry-standard data structure is defined in accordance with Extensible Markup Language (XML).

56. The computer system of claim 46, wherein the legacy data structure is a ‘C’ language defined data structure.

57. The computer system of claim 46, wherein a compiler generates the first stab information during a definition of the legacy data structure.

58. The computer system of claim 46, wherein the legacy data structure is partly defined by a legacy-language data structure definition and is partly defined by a legacy application's behavior.

59. The computer system of claim 48, wherein the definition of the primitive structure layout includes a definition of at least one data element type, and wherein the Perl utility is configured to assign a unique name to the at least one data element type, and to identify the at least one data element type as one of a character, a character string, a character array, and an integer.

60. The computer system of claim 59, wherein the Perl utility is configured to assign to the at least one data element type a unique beginning memory address and a byte length.

61. The computer system of claim 48, wherein the extraction utility is configured to store the definition of the primitive structure layout in an ASCII file.

62. The computer system of claim 46, wherein the extraction utility generates the first extraction class to extract and convert lottery-game related data entries.

63. The computer system of claim 62, wherein a lottery-game related data entry includes an indication of at least one of a lottery game type, a point of sale location, a set of selected numbers, and a time of sale.

64. The computer system of claim 63, wherein the lottery-game related data entry is automatically generated during a lottery game sale transaction.

65. The computer system of claim 62, further comprising:
a legacy application,
wherein the legacy application aggregates the lottery-game data entries from a plurality of point of sale devices, and stores, according to the legacy data structure, in a data buffer the aggregated entries, and
wherein each of the stored lottery-game data entries is extracted is extracted from the data buffer and converted to be in accordance with the industry-standard data structure.

66. The computer system of claim 65, further comprising:
a non-legacy application,
wherein the non-legacy application calculates lottery-game statistics based on the converted lottery-game data entries, and generates a lottery-game statistics report.

67. The computer system of claim 46, wherein the first extraction class is configured to output the converted data entry, wherein the converted data entry includes a plurality of data elements, and wherein only a first subset of the plurality of data elements is selected for output.

68. The computer system of claim 67, wherein the extraction utility is configured to automatically select the first subset of the plurality of data elements based on the first subset's relevance to tasks performed by a data processing application.

69. The computer system of claim 67, further comprising:
a user interface,
wherein the extraction utility is configured to provide to a user, via the user interface, a list of the plurality of data elements, and to receive the selection via the user interface,
wherein the selection is a choice from the list, and
wherein the first extraction class is configured to output the converted data entry in accordance with the selection.

70. The computer system of claim 46, wherein the extracted data entry includes a plurality of data elements, and wherein only a first subset of the plurality of data elements is selected for conversion.

71. The computer system of claim 70, wherein the extraction utility is configured to automatically select the first subset of the plurality of data elements based on the first subset's relevance to tasks performed by a data processing application.

72. The computer system of claim 70, further comprising:
a user interface,
wherein the extraction utility is configured to provide to a user, via the user interface, a list of the plurality of data elements, and to receive the selection via the user interface,
wherein the selection is a choice from the list, and
wherein the first extraction class is configured to convert the extracted data entry in accordance with the selection.

73. The computer system of claim 46,
wherein the data entry includes a first data entry and a second data entry,
wherein the legacy data structure includes a first legacy data structure and a second legacy data structure,
wherein the first data entry is input in accordance with the first legacy data structure and the second data entry is input in accordance with the second legacy data structure, and
wherein only the first data entry is selected for the extraction.

74. The computer system of claim 73, wherein the extraction utility is configured to automatically select the first data entry based on the first data entry's relevance to tasks performed by a data processing application.

75. The computer system of claim 73, further comprising:
a user interface,
wherein the extraction utility is configured to provide to a user, via the user interface, a listing of the first and the second legacy data structures, and to receive the selection via the user interface,
wherein the selection is a choice from the listing, and
wherein the first extraction class is configured to extract the data entry in accordance with the selection of the first legacy data structure.

76. The computer system of claim 46, wherein the first extraction class is a Java extraction class.

77. The computer system of claim 76, wherein the first extraction class implements at least one Java Document Object Model (JDOM) to extract the data entry.

78. The computer system of claim 46, wherein, when input, the data entry is encoded in one of a plurality of nibbles and a plurality of bytes.

79. The computer system of claim 46, wherein the first extraction class is configured to output the data entry, and wherein the outputted data entry is configured to be transmitted toward at least one data processing application.

80. The computer system of claim 79, wherein the transmission is in accordance with a predetermined standard.

81. The computer system of claim 80, wherein the predetermined standard is Transmission Control Protocol/Internet Protocol (TCP/IP).

82. The computer system of claim 46,
wherein the legacy data structure includes a first data structure and a second data structure, and
wherein a bitmap indicates in accordance with which of the first and second legacy data structures the data entry was input.

83. The computer system of claim 82, wherein the first extraction class extracts the data entry in accordance with the bitmap.

84. The computer system of claim 82, wherein one of the first and second legacy data structures is defined for input of lottery game winnings data.

85. A method for processing at least one of a plurality of lottery-game related data entries, input in accordance with at least one of a plurality of ‘C’ language defined legacy data structures, comprising:
detecting a first stab information, the first stab information generated during a first legacy data structure definition;
detecting a second stab information, the second stab information generated during a second legacy data structure definition;
automatically generating a first structure-layout data according to the first stab information after the first stab information is detected and before the second stab information is detected;
automatically generating a second structure-layout data according to the second stab information after the second stab information is detected,
the generation of the first and the second structure-layout data including respectively defining a first and a second primitive structure layout, and respectively defining a first and a second industry-standard data structure in accordance with Extensible Markup Language (XML) so that each of the first and the second industry-standard data structures is representative of its corresponding primitive structure layout;
storing the first and the second primitive structure layouts in at least one ASCII file;
automatically generating a first Java extraction class according to the first industry-standard data structure;
automatically generating a second Java extraction class according to the second industry-standard data structure;
storing a time of generation for each of the first and the second Java extraction classes;
storing a time of input for each of the plurality of data entries;
providing to a user a list of a plurality of data elements of the at least one data entry;
providing to the user a listing of a first and a second ‘C’ language defined legacy data structure of the plurality of ‘C’ language defined legacy data structures;
receiving a first user selection of only a first subset of the plurality of data elements, only the selected subset to be converted, the first user selection being a choice from the list;
receiving a second user selection of only the first ‘C’ language defined legacy data structure, the second selection being a choice from the listing, the plurality of data entries including a first set of data entries and a second set of data entries, the first set input in accordance with the first ‘C’ language defined legacy data structure, the second set input in accordance with the second ‘C’ language defined legacy data structure, wherein, in accordance with the second selection, only the first set is to be extracted,
in accordance with the second selection, extracting a data entry of the first set, the extraction being via one of the first and the second Java extraction classes, in accordance with the times;
in accordance with the first selection, converting the extracted data entry to be in accordance with the industry-standard data structure;
outputting the converted data entry; and
transmitting, in accordance with a Transmission Control Protocol/Internet Protocol (TCP/IP), the outputted data entry toward at least one data processing application,
wherein the first set includes a first entry input at a first time and a second entry input at a second time, the first and the second entries extracted by the first Java extraction class,
wherein the second stab information is detected after the first Java extraction class is generated,
wherein the first set includes a third entry input at a third time,
wherein, if the third entry is input before the second Java extraction class is generated, the third entry is extracted by the first Java extraction class,
wherein, if the third entry is input after the second Java extraction class is generated, the third entry is extracted by the second Java extraction class,
wherein the third entry is extractible after the second Java extraction class is generated, even if the third entry is input before the second Java extraction class is generated,
wherein, the first ‘C’ language defined legacy data structure is partly defined by a legacy-language data structure definition and is partly defined by a legacy application's behavior,
wherein, defining the first and the second primitive structure layout includes defining for each of the first and the second primitive structure layouts an associated at least one data element type,
wherein the at least one data element type is assigned a unique name, a unique beginning memory address, and a byte length, and is identified as one of a character, a character string, a character array, and an integer,
wherein at least one Java Document Object Model (JDOM) is implemented by the one of the first and the second Java extraction classes to extract the data entry of the first set,
wherein, when input, the data entry of the first set is encoded in one of a plurality of nibbles and a plurality of bytes.

86. An article of manufacture comprising a computer-readable medium having stored thereon instructions adapted to be executed by a processor, the instructions which, when executed, define a series of steps to be used to control a method for processing a data entry that is input in accordance with a legacy data structure, the method comprising:
automatically generating an extraction class according to a first stab information;
extracting the data entry via the extraction class; and
converting the data entry to be in accordance with an industry-standard data structure.
